(19) United States
(12) Patent Application Publication
(10) Pub. No.: US 2026/0309475 A1
(43) Pub. Date: Oct. 8, 2026

(54) COORDINATE POSITIONING MACHINE

(71) Applicant: RENISHAW PLC, Wotton-under-Edge, Gloucestershire (GB)

(72) Inventors: Julius Benjamin DUPREZ, Marne La Vallee (FR); Jean-Louis GRZESIAK, Marne La Vallee (FR)

(73) Assignee: RENISHAW PLC, Wotton-under-Edge, Gloucestershire (GB)

(21) Appl. No.: 18/996,696

(22) PCT Filed: Jul. 28, 2023
(86) PCT No.: PCT/EP2023/071007

§ 371 Date: Jan. 17, 2025

(30) Foreign Application Priority Data
Jul. 28, 2022 (EP) 22306131.8

(51) Int. Cl. G01B 5/008

(52) U.S. Cl. CPC G01B 5/008

(57) ABSTRACT

A method determines an offset of a feature associated with a tool, where the offset is defined relative to a first part of a machine to which the tool is coupled. The method is characterised by determining the offset from: (a) values for the position and orientation of the first part relative to a second part of the machine for each of a plurality of sensed states in each of which the feature is in a sensed position; and (b) information relating to where the sensed positions are relative to one another. A particularly beneficial example is disclosed in which the method is used to determine the tool centre point of a measurement probe supported on a robot arm using an artefact placed in the working volume of the robot arm.

The present invention relates to a coordinate positioning machine. The present invention relates in particular, but not exclusively, to a system for calibrating or otherwise characterising at least some aspect of a coordinate positioning machine. The present invention is particularly applicable, for example, to a non-Cartesian type of coordinate positioning machine, such as a hexapod, measurement arm or articulated robot.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

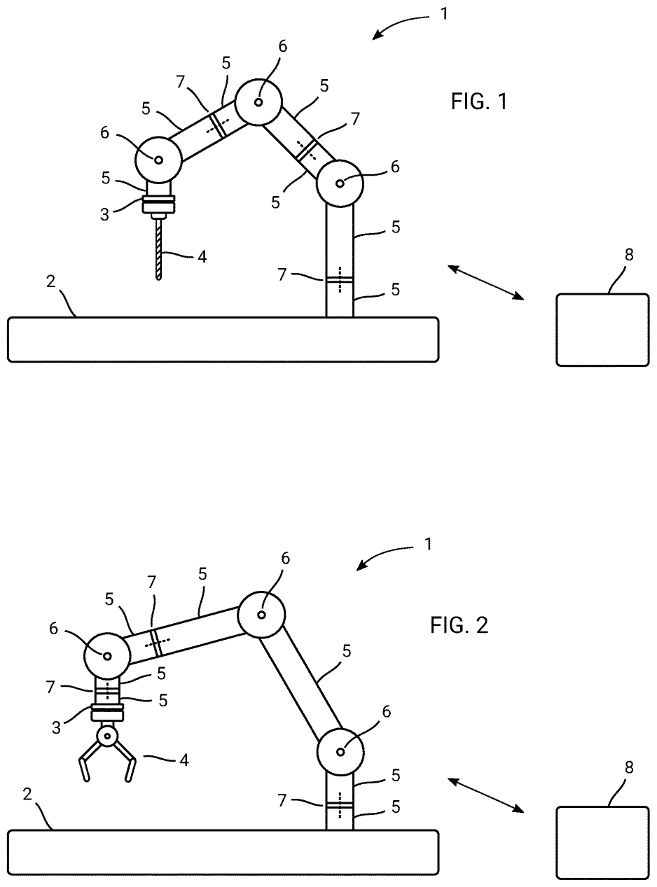

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. The tool 4 in FIG. 1 is a drilling tool. Typically, the flange 3 is provided with a coupling which allows for the tool 4 to be conveniently interchangeable, so that a variety of tools or end effectors can be employed depending on the application concerned; examples include grippers, vacuum cups, cutting tools (including both mechanical and laser cutting tools), drilling tools, milling tools, deburring tools, welding tools and other specialized tools. The flange 3 is also referred to more generally as the “head” of the robot arm 1, with the fixed base 2 being the “base”, and with the robot arm 1 being controlled to move the head relative to the base by commands from a machine controller 8.

The arm 1 comprises a plurality of segments 5 connected by a mixture of transverse rotary axes 6 and inline (or longitudinal) rotary axes 7, forming a mechanical linkage from one end to the other. In the example illustrated in FIG. 1, there are three transverse rotary axes 6 and three inline rotary axes 7, making a total of six rotary axes, alternating between transverse rotary axes 6 and inline rotary axes 7. An additional inline rotary axis 7 (not shown in FIG. 1) could also be provided between the final transverse rotary axes 6 and the flange 3, to provide convenient rotation of the tool 4 around its longitudinal axis, making a total of seven rotary axes.

Another common arrangement is shown in the arm 1 of FIG. 2, which includes the additional inline rotary axis 7 mentioned above, between the final transverse rotary axis 6 and the flange 3, and which also omits the second inline rotary axis 7 from FIG. 1 (in series order from the base end to the head end), thereby making a total of six rotary axes. The tool 4 in FIG. 2 is a gripper. The arm 1 of FIG. 1 is a schematic representation of the well-known IRB 140 six-axis industrial robot by ABB Robotics. The final three axes 6, 7 form a “wrist” of the robot arm 1, with the centre of the wrist being at the centre of the final transverse rotary axis 6. The centre of the wrist is invariant to rotation of the three rotary axes 6, 7 of the wrist, such that operation of the three rotary axes 6, 7 changes the orientation of whatever is attached to the wrist (in this case the gripper 4) without changing the position of the wrist centre, with the first three rotary axes 6, 7 of the robot arm 1 determining the position of the wrist centre. The wrist may be readily detachable from the remainder of the arm 1.

The articulated robot arms 1 of FIGS. 1 and 2 are examples of a non-Cartesian coordinate positioning machine because, in contrast to a Cartesian machine such as a traditional three-axis (X, Y, Z) coordinate measuring machine (see for example FIG. 1 of PCT/GB2020/052593), its axes are not arranged orthogonally according to a Cartesian coordinate system. The arms 1 of FIGS. 1 and 2 are also examples of a “serial kinematic” coordinate positioning machine, because their axes of movement are arranged in series. In this sense, such a machine is similar to a traditional three-axis Cartesian coordinate measuring machine, which is also an example of a “serial kinematic” coordinate measuring machine, and is to be contrasted with a “parallel kinematic” coordinate positioning machine such as a hexapod whose axes of movement are arranged instead in parallel.

Each joint or axis in a coordinate positioning machine contributes a positional error or uncertainty. In a serial kinematic machine such as that shown in FIGS. 1 and 2, because of the serial nature of the linkages, these errors are cumulative. Whilst this accumulation of positional errors does not occur in the same sense with a parallel kinematic machine, regardless of machine type it is important to calibrate the machine in order to map out these errors or uncertainties.

Calibration of any type of non-Cartesian machine is a significant challenge, and particularly so for an articulated arm such as that illustrated in FIGS. 1 and 2 having a plurality of rotary axes that are: (a) arranged in series; (b) are not fixed relative to one another; and (c) that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose.

Many calibration techniques have in common the goal of specifying a parametric model of the machine concerned, in which a set of model parameters (also referred to as machine parameters) is used to characterise the machine's geometry. Uncalibrated values are initially assigned to these parameters as a starting point for the machine geometry. During the calibration, the machine is moved into a variety of different poses (based on the current estimates of the machine parameters). For each pose, a calibrated measuring device is used to measure the actual pose, so that an indication of the error between the assumed machine pose and the actual machine pose can be determined. The task of calibrating the machine then amounts to determining a set of values for the various machine parameters that minimises the errors, using known numerical optimisation or error minimisation techniques.

For a robot arm as illustrated in FIGS. 1 and 2, these machine parameters might include various geometrical parameters such as the length of each of the segments 5 and the rotation angle offset of each of the rotary axes or joints 6, 7 (with the angle from the encoder plus the calibrated offset giving the actual angle), as well as various mechanical parameters such as joint compliance and friction. The machine parameters might also include the offset coordinates of the working point of the tool, such as the tip of the drilling tool 4 of FIG. 1, relative to the head or flange 3. In this respect, the offset of the working point (or tool centre point) is an important piece of information, and this will be discussed in more detail below.

When properly calibrated, with all of these machine parameters known, it is possible to predict with more certainty in what position the working point (or tool centre point) of the tool 4 will actually be when the various axes or joints 6, 7 are commanded by the controller 8 to move to different respective positions. In other words, the machine parameters resulting from such a calibration provide a more accurate characterisation of the machine geometry. These concepts, relating to calibration of coordinate positioning machines in general, and robot arms in particular, are explored in greater detail in WO 2019/162697 A1 and WO 2021/116685A1 .

The present applicant has appreciated that performing such a calibration routine can be complicated and time consuming, particularly where only a subset of the machine parameters is required, and more particularly where it is only required to determine the offset of a point of interest (e.g. a working point or tool centre point) of a tool supported on the machine.

The present applicant has also appreciated that there may be circumstances in which the full geometry of the machine concerned is not available, and that it is therefore desirable to provide a calibration routine that does not require knowledge of the full set of machine parameters that normally form part of a typical calibration routine as discussed above.

Robot arms such as depicted in FIGS. 1 and 2 are most typically used for positioning tasks, and are not typically considered to be sufficiently accurate for measurement tasks. However, the present applicant has also appreciated the desirability of a calibration routine that can be performed relatively quickly to find (or re-find) the offset of a measurement probe supported on a robot arm.

According to a first aspect of the present invention, there is provided a method of determining an offset of a feature of or associated with a tool. The offset is defined relative to a first part of a coordinate positioning machine to which the tool is coupled or attached, for example relative to a point or frame of reference on or associated with the first part. The method is characterised by determining the offset from: (a) values for the position and orientation of the first part relative to a second part of the machine for each of a plurality of sensed states for the first part, in each of which sensed states the feature is in a sensed position; and (b) information concerning or relating to where the sensed positions are at least relative to one another.

With an embodiment of the present invention the offset of the tool can beneficially be determined using only values for the position and orientation of the part of the coordinate positioning machine to which the tool is coupled, for example the head or flange of a robot arm, without having to know anything about how the remainder of the machine is arranged, or anything about the geometry of the machine or the parametric model that is used to characterise the geometry of the machine (and which would be used by the machine controller to derive values for the position and orientation of the part of the machine to which the tool is coupled). All that is required in an embodiment of the present invention are values for the position and orientation of the part to which the tool is coupled, along with knowledge of where the sensed positions are relative to one another. This greatly simplifies the process of determining the tool offset, since it does not involve a full calibration of the machine (for all model parameters including parameters for the tool offset) and this in turn encourages the perform the method more frequently than otherwise would be the case, thereby allowing the machine to be maintained in good operational order. By using position and orientation values that are readily available as output from any machine controller, this also allows the method to be implemented independently of any proprietary (and possibly locked down) machine control software that is used to control the machine, where it would be difficult or impossible to access detailed information about the geometry of the machine or a parametric model that is used to characterise the geometry of the machine.

The information may be or may have been obtained by measuring the sensed positions relative to one another. The information may comprise measurements of the sensed positions, at least relative to one another, or measurements from which it can be determined where the sensed positions are relative to one another. The measurements may be taken using a non-contact measurement system such as a camera-based system or from a contact measurement system such as with a tool setter probe. The method may comprise measuring the sensed positions relative to one another.

The information may be or may have been obtained by constraining the sensed positions relative to one another. The sensed positions may be or may have been constrained relative to one another by moving the feature into a sensing relationship with an artefact having a known geometry, supported on the second part. The artefact may have a spherical geometry or an at least part-spherical geometry. The method may comprise constraining the sensed positions relative to one another.

The tool may be a measurement probe. The method may comprise using the measurement probe to detect when the feature is in each of the sensed positions. The method may comprise using the measurement probe to detect when the first part is in each of the sensed states. The measurement probe may be a contact probe. The feature may be (or may be at or within) a tip of the measurement probe or of a stylus of the measurement probe. Where an artefact is used as mentioned above, the method may comprise detecting that the feature is in a sensed position or that the first part is in a sensed state when the measurement probe has moved into a sensing relationship with the artefact.

The feature of or associated with the tool may be a point of interest of or associated with the tool, and in particular may be a tool centre point of the tool. The coordinate positioning machine may be a robot arm. In this respect, a particularly beneficial embodiment of the present invention is where the method is used to determine a tool centre point of a measurement probe that is supported on a robot arm, using an artefact placed in the working volume of the robot arm. A method embodying the present invention is straightforward to perform, making it quicker and easier to set up a robot arm for measurement tasks using a robot arm (thereby in effect creating a measurement arm), and to perform the method frequently to maintain the measurement accuracy of the robot arm (or measurement arm). A robot arm is not typically considered for measurement tasks at least in part because of its serial kinematic architecture in which positioning errors tend to accumulate along the serial kinematic chain of links and joints, but an embodiment of the present invention makes it far more convenient to do so.

However, whilst the application to a robot arm carrying a measurement probe is particularly beneficial, it will be appreciated that the present invention is not limited to the machine being a robot arm, nor is it limited to the tool being a measurement probe. The machine may be any type of non-Cartesian and/or serial kinematic and/or parallel kinematic coordinate positioning machine, such as a hexapod or a robot arm, and the tool may be any type of tool, such as a drilling tool or welding tool or other type of mechanical tool or gripper. A robot arm may also be referred to as (and is equivalent to) an articulated robot or an articulated robot arm.

The method may comprise controlling the machine to move the first part relative to the second part into the plurality of different sensed states. The machine may be controlled (or may at least be caused to be controlled, for example by setting up a controller appropriately) to move the first part relative to a second part of the machine into the plurality of different sensed states for the first part. In each of the sensed states, the feature is in a sensed position relative to the second part.

A sensed state may be characterised by a position and orientation of (or by position and orientation values for) the first part relative to a second part. The sensed positions may be constrained or measured relative to one another and/or relative to the second part, and these may be denoted relative constraints or measurements.

As already noted, the sensed positions may be constrained relative to one another and/or relative to the second part by moving the feature into a sensing relationship with an artefact supported on the second part, with the artefact having a known geometry. In this case, the relative constraints mentioned above would be provided by or based on the known geometry of the artefact. The offset may then be determined based on (or taking account of) the known geometry of the artefact. The method may comprise the step of constraining or measuring the sensed positions relative to one another and/or relative to the second part.

The position and orientation values may specify the position and orientation of the first part relative to the second part independently of and/or without reference to the state and/or geometry and/or position and/or orientation of any other part of the machine that might affect and/or influence the position and orientation of the first part relative to the second part (for example the intermediate joints and links arranged between the base end and the head end of the serial kinematic chain of a robot arm). The position and orientation values may comprise numerical values for the position and orientation of the first part relative to the second part for each of the sensed states.

It may be that the offset is determined using only the position and orientation values and the information relating to where the sensed positions are relative to one another. It may be that the offset is determined from the position and orientation values without knowledge of and/or without reference to the machine geometry or a model, such as a parametric model, which characterises the geometry of the machine.

The position and orientation values for each of the sensed states may be received from an external source, for example from a machine controller that is used to control the machine to move the first part into the plurality of different sensed states. These position and orientation values may then be used to determine the offset mentioned above, based on (or taking account of) the relative constraints or measurements. The method may comprise requesting the position and orientation values from the external source (e.g. machine controller).

The position and orientation values may be or may have been derived from a model, such as a parametric model, which characterises the geometry of the machine. The external source mentioned above (such as the machine controller) may have already derived the position and orientation values based on the machine geometry or based on a model (such as a parametric model) of the machine that characterises the geometry of the machine. Accordingly, it may be that the method does not itself derive the position and orientation values and/or does not itself rely on any knowledge of the machine geometry (or a parametric model of the machine) to derive the position and orientation values, but instead receives the position and orientation values from elsewhere. In other words, it may be that the method does not include a step of deriving the position and orientation values from a model, such as a parametric model, which characterises the geometry of the machine

The sensed states may comprise a plurality of different positions for the first part relative to the second part. The sensed states may comprise a plurality of different orientations for the first part relative to the second part. The sensed states may comprise a plurality of different orientations for the first part relative to the second part for at least one of (or at least some of, or each of) the sensed positions for the feature. The sensed states may comprise at least three or at least four different orientations for the first part relative to the second part for each of the sensed positions for the feature. The sensed states may comprise at least three or at least four different sensed positions for the feature.

The method may comprise moving the first part into the sensed states based on a current estimate for the offset. The method may comprise using the position and orientation values to update or optimise the current estimate for the offset to provide a closer correspondence to the relative constraints or measurements.

The machine may comprise a plurality of joints or axes arranged in series between the first and second parts. The joints or axes may be rotary and/or linear joints or axes. The machine may be adapted to provide relative movement between the first and second parts in a plurality of degrees of freedom. The machine may be provided with a plurality of degrees of freedom for relative movement between the first and second parts. The first part may be a moving part or head of the machine and the second part may be a fixed part or base of the machine. Alternatively, the first part may be a fixed part or base of the machine and the second part may be a moving part or head of the machine.

According to another aspect of the present invention, there is provided a program which, when run by a computer or a calibration unit or some other type of processing unit, causes the computer or calibration unit or processing unit to perform a method according to the first aspect of the present invention (or at least any steps of the method that can be performed or caused to be performed by the computer or calibration unit or processing unit).

According to another aspect of the present invention, there is provided a medium having stored therein program instructions for controlling a computer or a calibration unit or some other type of processing unit to perform a method according to the first aspect of the present invention (or at least any steps of the method that can be performed or caused to be performed by the computer or calibration unit or processing unit).

According to another aspect of the present invention, there is provided a calibration unit or some other type of processing unit configured to perform a method according to the first aspect of the present invention (or at least any steps of the method that can be performed or caused to be performed by the calibration unit or processing unit).

According to another aspect of the present invention, there is provided a machine configured to perform a method according to the first aspect of the present invention.

Reference will now be made, by way of example, to the accompanying drawings, in which:

FIG. 1, discussed hereinbefore, is a schematic illustration of a coordinate positioning arm in the form of an articulated robot, and carrying a drilling tool;

FIG. 2, also discussed hereinbefore, is a schematic illustration of an articulated robot having a different arrangement of rotary axes to that of FIG. 1, and carrying a gripping tool;

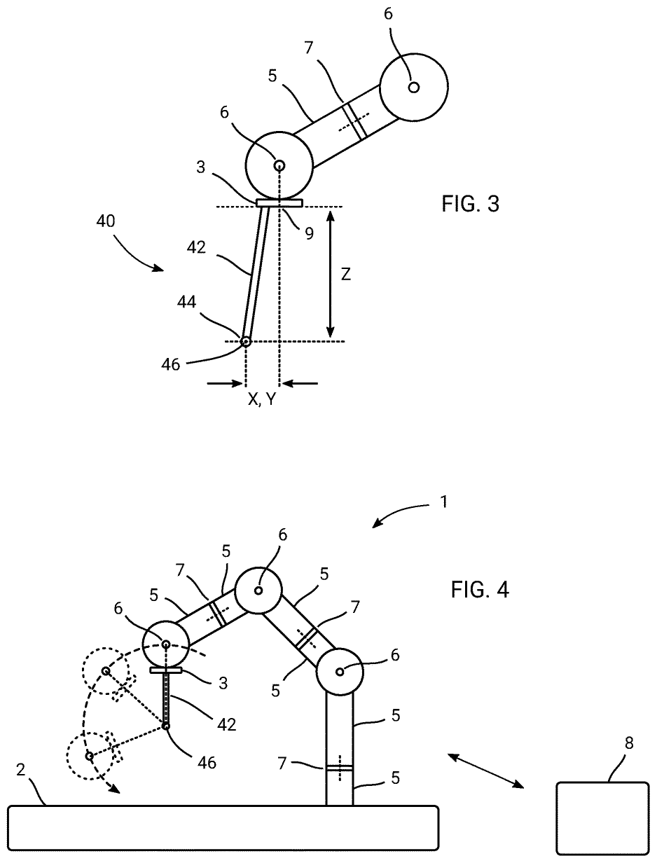

FIG. 3 is a schematic diagram for use in illustrating and describing in more detail the concept of a tool centre point;

FIG. 4 schematically illustrates a robot moving an attached tool in such a way that the tool centre point should remain in the same position;

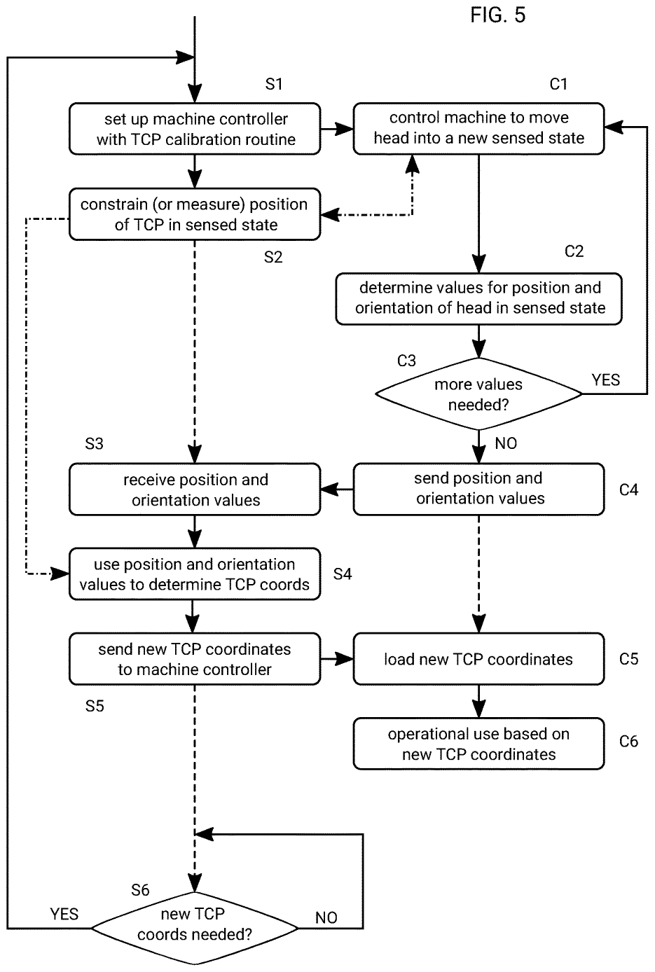

FIG. 5 shows a method embodying the present invention in the form of a flowchart, the method in this embodiment being for determining the offset of a tool centre point of a measurement probe carried on a robot arm;

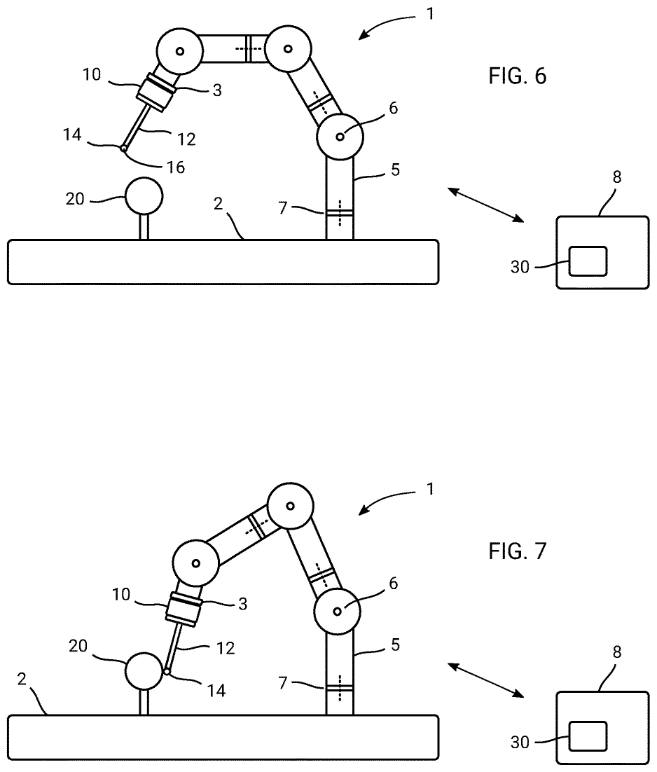

FIG. 6 is a schematic illustration of a robot arm carrying a measurement probe, along with a calibration artefact and a calibration unit for implementing the method of FIG. 5;

FIG. 7 shows the robot arm of FIG. 6 when the head of the robot arm has been moved into a sensed state in accordance with the method of FIG. 5;

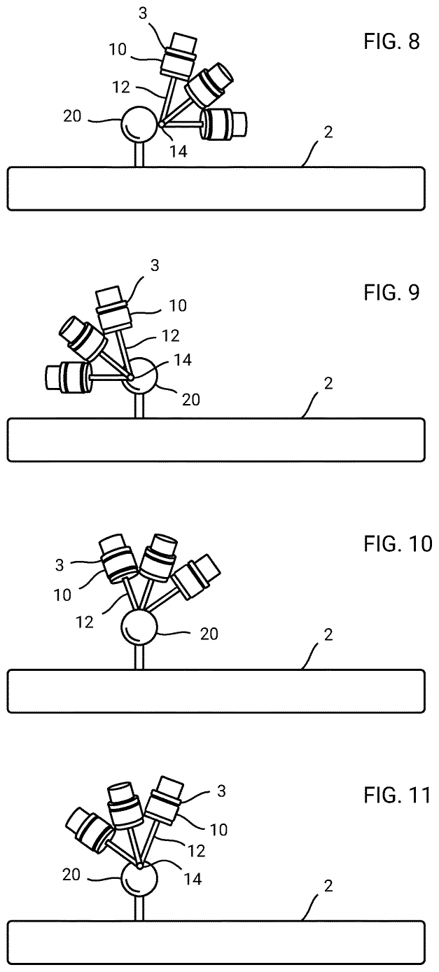

FIGS. 8 to 11 illustrate the head of the robot arm being moved into a plurality of different sensed states in accordance with the method of FIG. 5;

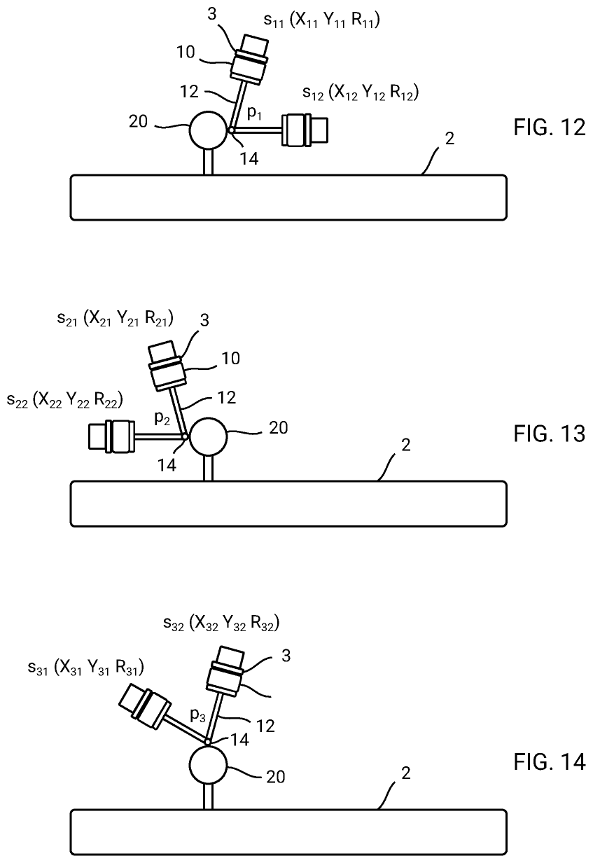

FIGS. 12 to 14 show a simplified two-dimensional representation of the head of the robot arm being moved into a plurality of different sensed states;

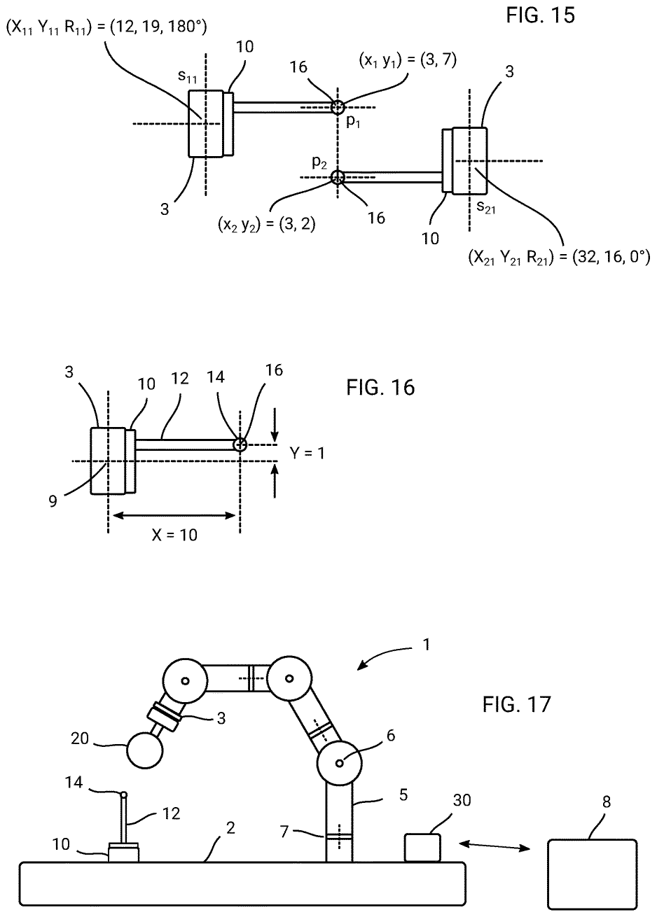

FIG. 15 show a highly simplified two-dimensional representation of the head of the robot arm being moved into two different sensed states;

FIG. 16 shows the tool centre point offset values determined based on the sensed states and constraints depicted in FIG. 15;

FIG. 17 shows an alternative arrangement embodying the present invention, with the measurement probe is supported on the fixed base and the calibration artefact supported on the moving head of the robot arm;

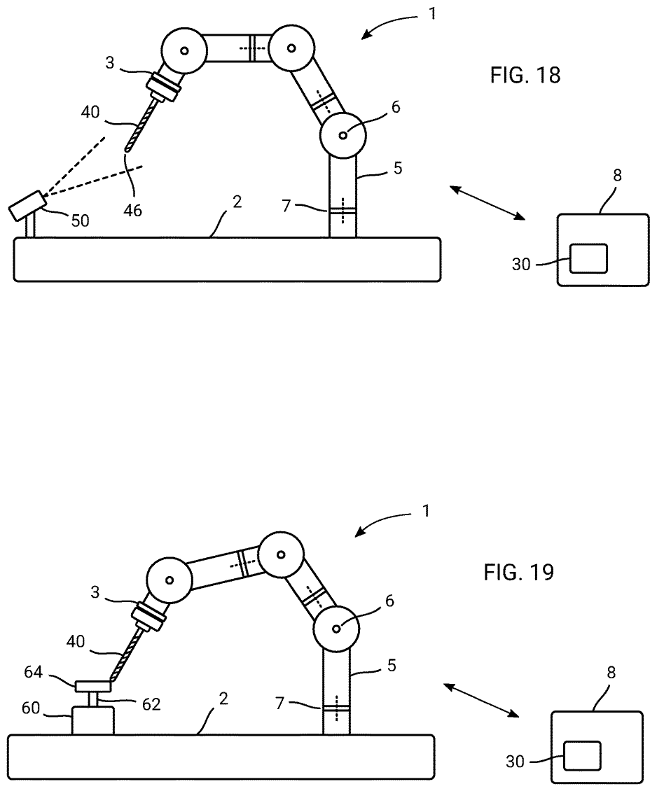

FIG. 18 illustrates that an external position measurement device can be used instead of a calibration artefact in an embodiment of the present invention; and

FIG. 19 illustrates the possibility that a toolsetter can be used as the external measurement device.

FIG. 3 shows a schematic representation of a tool 40 attached to a flange 3 of a robot arm of a type as described above with reference to FIGS. 1 and 2. The tool 40 has an elongate member 42 that is mounted at an angle to the flange 3 (the mounting angle may be deliberate or it could be inadvertent), with a tip 44 at a distal end of the elongate member 42. The centre 46 of the tip 44 is a particular point of interest because it would typically be the working point of the tool 40, or some other important reference point associated with the tool 40, and in a robot architecture this is commonly referred to as the tool centre point or TCP of the tool 40.

When programming a robot to move the tool 40 around the working volume, the location of the tool centre point 46 relative to the part of the robot to which the tool 40 is attached, i.e. the flange 3 in this case, is an important piece of information. Specifying the coordinates or offset (X, Y, Z) of the tool centre point 46 is a key step when setting up any robot for operational use. The tool centre point 46 is the point in relation to which all robot positioning is defined, and constitutes the origin of the tool coordinate system. The tool centre point 46 might correspond, for example, to the tip of an arc welding gun, the centre of a spot welding gun, the end of a grading tool, or the tip of a drilling tool such as that shown in FIG. 1. The location of the tool centre point 46 will therefore depend on the application concerned.

It is to be noted that knowledge of the coordinates or offset of the tool centre point 46 does not imply knowledge of the orientation of the tool 40 relative to the flange 3, nor does it imply knowledge of the length of the tool 40, because the tool centre point 46 is defined relative to an arbitrary point (or frame of reference) 9 on the flange 3 that is known and defined internally, and this does not necessarily correspond to the point at which the elongate member or shaft 42 of the tool 40 is actually attached to the flange 3, as indeed is the case in the schematic example shown in FIG. 3. Therefore, determining the tool centre point 46 of the tool 40 is not the same as, and does not amount to, determining the orientation or direction or length or size of the tool 40.

In operation, it is the tool centre point 46 that will be jogged around or moved to the desired target position with the desired tool orientation. For example, with reference to the “wrist” concept for a robot arm of a type as described above with reference to FIG. 2, the first three rotary axes of the robot arm can be controlled to set the position of the wrist centre, the three rotary axes of the wrist can be used to change the orientation of the flange 3 relative to the first three axes, and the position of the key point of the working tool 40 relative to the flange 3 can be determined from the tool centre point (TCP) information. By knowing and controlling these aspects of the robot architecture, the position of the working point 46 of the tool 40 can be controlled in a relatively straightforward manner.

FIG. 4 schematically illustrates the robot arm 1 being instructed by the controller 8 to move the tool 40 so that the tool centre point 46 of the tool 40 remains in the same position, or at least should ideally remain in the same position. Such a test is typically performed to verify that the tool centre point 46 has been correctly identified and is sometimes known as a “tool orientation test”. The objective is to assess the robot's accuracy (and the accuracy of the coordinates X, Y, Z of the tool centre point 46 as shown in FIG. 3) by measuring its ability to rotate around the tool centre point 46 that is programmed into the controller 8, ideally without any actual movement of the tool centre point 46 being apparent when the test is being performed.

However, rather than merely verify the position of the TCP as is done with the tool orientation test, the aim of an embodiment of the present invention to determine the position of the TCP. The most common method currently is the pin-to-pin method in which the operator visually aligns two pins with different orientations, one of which is fixed on the machine base and the other of which is moveable by the robot to reference the TCP, with the robot being controlled manually by an operator. This is a convenient method, but it is relatively inaccurate because it depends to a large extent on the skill and experience of the operator; it also requires the tool 40 to be removed and replaced by the pin.

Furthermore, an embodiment of the present invention is particularly, though not exclusively, intended to be applicable where the working tool 4, 40 of FIGS. 1 to 3 is a surface sensing device such as a measurement probe, which is adapted to sense the surface of a workpiece and to determine the coordinates of points on the workpiece. Such surface sensing devices are well known and will not be described in detail here. They can be contact or non-contact surface sensing devices, optical or mechanical.

A method embodying the present invention will now be described with reference to the flowchart of FIG. 5, with FIG. 6 being a schematic illustration of an example of a calibration system which implements the method of FIG. 5. The calibration system of FIG. 6 includes a robot arm 1 that is generally equivalent to that described above with reference to FIGS. 1 and 2, having a plurality of segments 5 connected by a combination of transverse rotary axes 6 and inline rotary axes 7. Compared to FIGS. 1 and 2, the robot arm 1 of FIG. 6 is carrying a measurement probe 10 rather than a drilling tool or gripper, and the calibration system of FIG. 6 also comprises a calibration artefact 20 and a calibration unit 30. The calibration artefact 20 has a known geometry, in this example having a spherical form with a diameter that has been measured accurately in advance, for example using a calibrated coordinate measuring machine or CMM under controlled conditions.

The concept of a tool centre point, as described above with reference to a working tool such as a drilling tool, applies equivalently to a surface sensing device such the measurement probe 10 of FIG. 6. In this respect, the measurement probe 10 depicted in FIG. 6 has an elongate stylus 12 and a surface-contacting stylus tip 14 at a distal end of the stylus 12, with the tool centre point 16 being defined at the centre of the stylus tip 14, which is equivalent to what is shown in the schematic illustration of the tool 40 in FIG. 3. The stylus tip 14 defines the key point of interest of the measurement probe 10 (the point of interest being the tool centre point 16), just as the tip of the drilling tool 4 of FIG. 1 defines the key point of interest (tool centre point) for such a tool.

The method of FIG. 5 is performed to determine the coordinates (or offset) of the tool centre point 16 associated with the measurement probe 10, with the coordinates (or offset) of the tool centre point 16 being defined relative to a point on the flange 3 of the robot arm 1 to which the measurement probe 10 is coupled. The flange 3 will also be referred to hereinbelow as the head part 3 of the robot arm 1, since it is at the head of the robot arm 1 and at the opposite end to the base part 2. As described previously, the robot arm 1 has a plurality of rotary joints (transverse rotary axes 6 and inline rotary axes 7) arranged in series between the head part 3 and the base part 2. The steps on the left side of the flowchart of FIG. 5, with reference numerals starting with “S”, are those steps that enable new functionality associated with an embodiment of the present invention, while the steps on the right side, with reference numerals starting with “C”, are those steps that are performed generally by a conventional machine (robot) controller 8 without the extra functionality provided by the calibration unit 30.

In step S1, the calibration unit 30 sets up the machine controller 8 to perform a calibration routine to collect information or data from which the TCP offset can be determined, as will be described in more detail below. The machine controller 8 begins the calibration routine in step C1 by controlling the robot arm 1 to move the head part 3 (on which the measurement probe 10 is supported) relative to the base part 2 (on which the calibration artefact 20 is supported) into a first sensed state, as shown in FIG. 7. A sensed state is characterised by a position and orientation of (or position and orientation values for) the head part 3 relative to the base part 2.

The head part 3 is in a sensed state when the tool centre point 16 of the measurement probe 10 is itself in a sensed position. A sensed position for the tool centre point 16 is a position in which the stylus tip 14 of the measurement probe 10 is in a sensing relationship with the calibration artefact 20, i.e. touching the calibration artefact 20 in this embodiment where the measurement probe 10 is a contact probe. Because the stylus tip 14 of the measurement probe 10 is in contact with the calibration artefact 20 in this position, the position of the tool centre point 16 has thereby been constrained to a subset of the overall set of possible positions for the tool centre point 16. This is represented by step S2 of FIG. 5. The subset of constrained positions in this embodiment is the set of points arranged on a surface that is offset from the calibration artefact 20 by the radius of the stylus tip 14. Using the calibration artefact 20 like this is one way to provide information relating to where the sensed positions are relative to one another, with this information being made available subsequently in step S4. As an alternative to constraining the position of the tool centre point 16 in this way to provide this information for step S4, the position of the tool centre point 16 could also be measured directly for each of the sensed positions, and this alternative is explored further below.

With the position of the tool centre point 16 being constrained in this way in step S2, and with the head part 3 determined to be in a sensed state as described above, in step C2 the controller 8 determines values for the position and orientation of the head part 3 relative to the base part 2 in this sensed state, based on the existing machine geometry (or parametric model) for the robot arm 1. In this respect, to be able to control the robot arm 1 to move appropriately the controller 8 must already have knowledge of the machine geometry for the robot arm 1 (or a parametric model characterising the geometry of the robot arm 1), and from this it is able to determine representative values for the position and orientation of the head part 3 relative to the base part 2 in a conventional way.

It is to be noted that the offset of the tool centre point 16 relative to the head part 3 is not relevant to the determination made in step C2. All that is required at this stage is the position and orientation of the head part 3, i.e. the part of the robot arm 1 to which the measurement probe 10 is coupled. It does not matter where the tool centre point 16 actually is, or is assumed to be, relative to the head part 3, merely that in the sensed state there is some knowledge of the position of the tool centre point 16 relative to the base part 2 due to the constraint imposed by the calibration artefact 20. It is also to be noted that the calibration unit 30 does not need (and does not have) knowledge of the machine geometry (or parametric model) for the robot arm 1, so that there is a functional even if not physical separation between the calibration unit 30 and controller 8 in this respect.

To collect sufficient information for the next stage (in particular, for step S4 performed by the calibration unit 30), position and orientation values for the head part 3 need to be determined for a variety of different sensed states. As shown schematically in FIGS. 8 to 11, sufficient information can be collected by repeating steps C1 and C2 for four different sensed positions of the tool centre point 16 around the calibration artefact 20, with the head part 3 (and therefore also the measurement probe 10) in three different orientations for each of the four different sensed positions. This amounts to twelve different sensed states and twelve corresponding pairs of position and orientation values for the head part 3.

Accordingly, in step C3 the controller 8 decides whether further sensed states (and corresponding position and orientation values) are required. If yes, the method returns to step C1 so that the controller 8 can control the head part 3 into a different sensed state, with the tool centre point 16 being constrained by the calibration artefact 20 as represented by step S2, and with position and orientation values for the head part 3 in the new sensed state being determined in step C2. If, on the other hand, it is decided in step C3 that sufficient calibration data have already been collected, e.g. for all twelve sensed states (and corresponding position and orientation combinations) shown in FIGS. 8 to 11, then control passes to step C4 in which the controller 8 sends the set of position and orientation values determined for each performance of step C2 to the calibration unit 30. Step C4 could also come before step C3, so that the position and orientation values are sent immediately to the calibration unit 30 rather than waiting until all values have been collected.

In step S3 the calibration unit 30 receives the set of position and orientation values sent from the controller 8, and in step S4 the calibration unit 30 uses these position and orientation values to determine the offset of the tool centre point 26. As represented by the arrow leading from step S2, the calculation which is performed in step S4 also takes account of the knowledge that in each of the sensed states for which position and orientation data is provided, the position of the tool centre point 16 was constrained relative to the position of the tool centre point 16 in another of the sensed states by virtue of the calibration artefact 20. Since the geometry of the calibration artefact 20 is known, the position and orientation data in combination with the constraint data (e.g. from a computer model of the calibration artefact) provides sufficient information to enable the offset of the tool centre point 16 relative to the head 3 to be determined directly in step S3. For example, with a spherical calibration artefact 20, it is known that the tool centre point 16 will in each of the sensed states be located on a spherical surface that is offset from the spherical calibration artefact 20 by the radius of the stylus tip 14, and this provides information about where the sensed positions are relative to one another.

FIGS. 12 to 14 show a simplified two-dimensional representation of FIGS. 8 to 11, in which the measurement probe 10 is considered to move only within the two-dimensional plane of the drawings page. The measurement probe 10 is moved so as to contact the stylus tip 14 at three different points around the artefact 20, i.e. with the tool centre point 16 being in three different sensed positions p₁, p₂ and p₃ around the artefact 20, as shown respectively in FIGS. 12, 13 and 14. For each of the sensed positions p₁, p₂ and p₃, the head part 3 is oriented in two different orientations, corresponding respectively to two different sensed states, e.g. sensed states s₁₁ and s₁₂ for sensed position p₁ of FIG. 12. Overall, therefore, there are six different sensed states s₁₁, s₁₂, s₂₁, s₂₂, s₃₁, s₃₂ for the head part 3. In this simplified two-dimensional example, each sensed state for the head part 3 is characterised by two position values (X Y) and an orientation or angle value (R), for example (X₂₁ Y₂₁ R₂₁) for sensed state s₂₁ as shown in FIG. 13, or more generally (X_{PS} Y_{PS} R_{PS}) where P is the number of the sensed position and S is the number of the sensed state (or orientation). Note again that these are position and orientation values for the head part (flange) 3 relative to the base part 2, so that the positions in this context are not the positions of the tool centre point 16 itself, although it is also to be noted again that the positions of the tool centre point 16 are constrained relative to one another by virtue of the calibration artefact 20.

FIG. 15 show a highly simplified two-dimensional representation of the head part 3 of the robot arm 1 being moved into two different sensed states s₁₁, s₂₁. The sensed positions p₁, p₂ of the tool centre point 16 in these two sensed states s₁₁, s₂₁ are constrained (or measured) relative to another such that the first sensed position p₁ is at (x₁ y₁)=(3, 7) and the second sensed position p₂ is at (x₂ y₂)=(3, 2), i.e. with a relative separation of (3, 7) (3, 2)=(0, 5). In the first (and only) sensed state s₁₁ for the first sensed position p₁, the head part 3 is determined by the controller 8 to have position and orientation values of (X₁₁ Y₁₁ R₁₁)=(12, 19, 180°), and in the first (and only) sensed state s₂₁ for the second sensed position, (X₂₁ Y₂₁ R₂₁)=(32, 16, 0°). The head part 3 has therefore been rotated around a full 180° between the two sensed states s₁₁, s₂₁.

Because, in this highly simplified example, it is known how the coordinate system of the sensed (and constrained/measured) positions p₁, p₂ relates to the coordinate system of the head part 4, e.g. that an orientation of 90° would align the head part 3 with the line between the first and second sensed positions, it is possible to determine the offset of the tool centre point 16 from just these two sensed states s₁₁, s₂₁. The relative separation between the head part 3 in the two sensed states is (32, 16)−(12, 19)=(20, −3). Taking account of the relative constraints/measurements (0, 5) of the sensed positions, this amounts to an adjusted relative separation of (20, 2), and therefore a tool centre point offset of (X Y)=(10, 1) as shown in FIG. 16. Again, as previously explained with reference to FIG. 3, this offset is relative to an arbitrary point (or frame of reference) 9 on the head part 3 and does not convey any information about the actual orientation of the measurement probe 10 (and stylus 12), which is clearly not oriented along vector (10, 1).

Although this is a highly simplified example, it demonstrates how the offset coordinates can beneficially be determined solely from the position and orientation values for the head part 3, without knowing anything about how the remainder of the robot arm 1 is arranged, or anything about the geometry of the robot arm 1 or of the parametric model which characterises the geometry of the robot arm 1. All that is required is information specifying the position and orientation of the head part 3 relative to the base part 2, along with some knowledge of where the sensed positions are relative to one another; indeed, the rest of the robot arm 1 (comprising the parts arranged between the head part 3 and the base part 2) is not even shown in FIG. 15. A conventional method to find the tool centre point offset would typically include the offset parameters as parameters in the model which characterises the geometry of the machine, so that the tool centre point offset parameters would be determined or optimised in parallel with other parameters of the model. With an embodiment of the present invention, the offset parameters are determined separately from and/or independently of the other parameters of model, and after the other parameters of model have been determined or optimised.

Even if the information received from the controller 8 in step s₃ is not specified directly in terms of explicit and final numerical values for position and orientation, and even if some type of minimal processing is required to produce actual numerical values for position and orientation (e.g. scaling or shifting or mapping values from one coordinate space to another), the information should at least specify the position and orientation of the head part 3 relative to the base part 2 without reference to the state and/or geometry of any other part of the robot arm 1 that might affect the position and orientation of the head part 3 relative to the base part 2 (such as the links 5 and joints 6 of the robot arm 1 shown in FIG. 6). For example, raw machine coordinate data from the controller 8 (comprising rotary encoder readings and/or joint angles) would not fit this description because, although it contains information from which the position and orientation of the head part 3 relative to the base part 2 could be derived, it does so with reference to the state and/or geometry of other machine components that are arranged in the kinematic chain between the base part 2 and the head part 3, and in doing so requires knowledge of the parametric model of the robot arm 1 in order to process.

The skilled person would understand how to extend the simplified example of FIGS. 15 and 16 to a full working example, gathering more position and orientation information for the head part 3 via more sensed states and sensed positions, as illustrated in FIGS. 8 to 11 for three dimensions and in FIGS. 12 to 14 for two dimensions, so that relative positional information for multiple sensed positions can be gathered in all three dimensions (FIGS. 8 to 11) or in both dimensions (FIG. 12 to 14) rather than effectively in just one dimension as per FIG. 15 (because there are only two sensed positions p₁, p₂). With this additional data it would not be necessary to make any assumptions about how the frame of reference for the constrained/measured sensed positions p₁, p₂ relates to the frame of reference for the sensed states s₁₁, s₂₁ of the head part 3.

Returning to the flowchart of FIG. 5, in step S5 the TCP coordinates determined in step S4 are sent to the controller 8 and loaded into the controller 8 in step C5. With the new TCP coordinates loaded into the controller 8, the robot arm 1 can then be used (or can continue to be used) operationally, with the controller 8 being able to determine more accurately from the new TCP coordinates what movements of the head part 3 are required to bring the stylus tip 14 of the measurement probe 10 precisely into contact with a workpiece to obtain measurement data. The setup of the robot arm 1 may drift over time, or the robot arm 1 may be knocked or moved inadvertently by an operator, so that it is beneficial to perform the method again occasionally or even frequently to determine up-to-date TCP coordinates, so if it is determined in step S6 that new TCP coordinate are needed then the method returns to step S1 for another run, otherwise the method remains at step S6 until a new run is deemed to be necessary.

A key benefit of the method described above is that the offset of the tool centre point 16 has been determined by the calibration unit 30 based only on the position and orientation values for the head part 3 sent from the controller 8, without any knowledge of the geometry of the robot arm 1 itself. This provides increased operational simplicity and versatility because it does not require integration into the controller 8 but can be provided as an add-on feature that is used in conjunction with a conventional controller 8. It also provides a very quick and convenient way of setting up a robot arm for a measurement (rather than positioning) task, allowing the offset of a measurement probe supported on a robot arm to be determined quickly and accurately, and also allowing the process to be repeated frequently because all that is required is for a calibration artefact 20 to be placed (or even to remain) in the working volume and for the automated routine to be started again to determine a fresh value for the TCP offset.

With the embodiment described above, the measurement probe 10 is supported on the head part 3 and the calibration artefact 20 is supported on the base part 2, so that the measurement probe 10 is moving relative to the base part 2. It is also possible to reverse this, as shown in FIG. 17, so that the measurement probe 10 is supported on the (fixed) base 2 and the calibration artefact 20 is supported on the (moving) head part 3. The method for this reversed arrangement of FIG. 17 is entirely equivalent to that described above. FIG. 17 also illustrates that the calibration unit 30 can be physically separate from the controller 8.

As already alluded to above, rather than using a calibration artefact 20 to provide the relative positional information for the sensed positions as required in step S4 (and as represented by the flow of information from step S2 to S4), it is instead possible to measure the position of the tool centre point 46 of a general tool 40 relative to the base part 2 for each of the sensed states by using external position measurement device 50 as shown in FIG. 18. This can be considered to provide a “virtual artefact” or a “virtual constraint”, because instead of knowing that the sensed positions for the tool centre point 16 lie relative to one another around a known sphere (or other shape as defined by the calibration artefact 20), the actual positions of the tool centre point 16 are measured so that it is again known where the sensed positions for the tool centre point 16 lie relative to one another, which is the same as when using a calibration artefact 20 with a known geometry. The sensed positions (i.e. the positions at which the tool centre point 46 are measured by the position measurement device 50) could even be chosen to lie around a sphere, thereby providing a “virtual constraint” having sensed positions similar to what would be provided by the calibration artefact 20.

It will therefore be understood that the method associated with the arrangement of FIG. 18 is entirely equivalent to that described above. The position measurement device 50 can be a laser-based position measurement device or a camera-based position measurement device, or any other suitable type of position measurement device. The arrangement of FIG. 18 also applies to the case where a measurement probe 20 is supported on the head part 3 rather than the general tool 40, in which case there is a position measurement device 50 taking position measurements of another position measurement device in the form of the measurement probe 20. FIG. 19 illustrates the possibility that a toolsetter 60 can be used as the measurement device, the toolsetter 60 having a stylus 62 and sensing element 64.

It will be appreciated that the calibration artefact 20 need not be spherical but could be any shape, such as cuboidal, so long as the geometry of the shape is known (this information being used in step S4 of FIG. 5), because this is sufficient to constrain the sense positions relative to one another. It will also be appreciated that the present invention is applicable to finding the offset of any feature or other point of interest associated with a tool, and not just a tool centre point of the tool. The head part and base parts can alternatively be referred to more generally as first and second parts of the machine that are moveable by the machine relative to one another. Furthermore, the terms ‘characterisation’ and ‘characterise’ can be used instead of ‘calibration’ and ‘calibrate’ respectively.

In some of the embodiments illustrated and described herein, such as is illustrated in FIG. 6, the calibration unit 30 is shown as forming part of the controller 8. However, as is illustrated in FIG. 17, the calibration unit 30 can conveniently be functionally and/or physically separate and/or remote from the controller 8, and merely receiving the information it needs from the controller 8; the calibration unit 30 could even be at a different site to the controller 8 and robot arm 1. The relevant data for step S4 of FIG. 5 could even be sent to a remote site for processing, rather than processed on site. The calibration unit 30 is intended to represent means for providing additional functionality associated with an embodiment of the present invention and that is not provided by a conventional controller, either additional functionality for the controller (e.g. to provide the servo control described above when collecting measurement data) or additional functionality outside the controller (e.g. offsite processing of the collected measurement data).

A machine controller for controlling the operation of the robot (or other type of coordinate positioning machine) may be a dedicated electronic control system and/or may comprise a computer operating under control of a computer program. For example, the machine controller may comprise a real-time controller to provide low-level instructions to the coordinate positioning machine, and a PC to operate the real-time controller. It will be appreciated that operation of the coordinate positioning machine can be controlled by a program operating on the machine, and in particular by a program operating on a coordinate positioning machine controller such as the controller 8. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A method of determining an offset of a feature associated with a tool, the offset being defined relative to a first part of a machine to which the tool is coupled, in which method the offset is determined using: (a) values for the position and orientation of the first part relative to a second part of the machine for each of a plurality of sensed states in each of which the feature is in a sensed position; and (b) information relating to where the sensed positions are relative to one another.

2. A method as claimed in claim 1, wherein the information is obtained by measuring the sensed positions relative to one another.

3. A method as claimed in claim 1, wherein the information is obtained by constraining the sensed positions relative to one another.

4. A method as claimed in claim 3, wherein the sensed positions are constrained relative to one another by moving the feature into a sensing relationship with an artefact supported on the second part and having a known geometry.

5. A method as claimed in claim 1, wherein the tool is a measurement probe.

6. A method as claimed in claim 5, comprising using the measurement probe to detect when the feature is in a sensed position.

7. A method as claimed in claim 5, wherein the feature is or is at a tip of the measurement probe or of a stylus of the measurement probe.

8. A method as claimed in claim 5, wherein the sensed positions are constrained relative to one another by moving the feature into a sensing relationship with an artefact supported on the second part and having a known geometry, and comprising detecting or determining that the feature is in a sensed position when the measurement probe has moved into a sensing relationship with the artefact.

9. A method as claimed in claim 1, wherein the feature is a point of interest of the tool.

10. A method as claimed in claim 1, wherein the offset is determined using only the position and orientation values and the information relating to where the sensed positions are relative to one another.

11. A method as claimed in claim 1. wherein the machine comprises a plurality of joints or axes arranged in series between the first and second parts.

12. (canceled)

13. (canceled)

14. A method as claimed in claim 1, wherein the position and orientation values are derived from a model, which characterises the geometry of the machine.

15. A method as claimed in claim 1, wherein the offset is determined from the position and orientation values without knowledge of and/or without reference to the machine geometry or a model, which characterises the geometry of the machine.

16. A method as claimed in claim 1, wherein the position and orientation values specify the position and orientation of the first part relative to the second part without reference to the state and/or geometry of any other part of the machine that might affect the position and orientation of the first part relative to the second part.

17. A method as claimed in claim 1, wherein the position and orientation values comprise numerical values for the position and orientation of the first part relative to the second part for each of the sensed states.

18. (canceled)

19. A method as claimed in claim 1, comprising receiving the position and orientation values from an external source being a machine controller used to control the machine to move the first part relative to the second part into the plurality of different sensed states.

20. (canceled)

21. A method as claimed in claim 1, wherein the sensed states comprise a plurality of different orientations for the first part relative to the second part.

22-24. (canceled)

25. A method as claimed in claim 1, comprising moving the first part into the sensed states based on a current estimate for the offset.

26-32. (canceled)

33. A medium having stored therein program instructions for causing a processing unit to perform a method as claimed in claim 1.

34. A processing unit configured to perform a method as claimed in claim 1.

35. (canceled)
